(19) United States
(12) Patent Application Publication
(10) Pub. No.: US 2019/0367773 A1
(43) Pub. Date: Dec. 5, 2019

(54) INVISIBLE FINGERPRINT COATINGS AND PROCESS FOR FORMING SAME

(71) Applicant: NBD NANOTECHNOLOGIES, INC., Danvers, MA (US)

(72) Inventors: Miguel GALVEZ, Danvers, MA (US); Bong June ZHANG, Chestnut Hill, MA (US); Esra ALTINOK, Medford, MA (US)

(21) Appl. No.: 16/422,329

(22) Filed: May 24, 2019

Related U.S. Application Data
(60) Provisional application No. 62/676,052, filed on May 24, 2018.

(51) Int. Cl. C09D 183/08; C09D 5/00; C09D 183/06

(52) U.S. Cl. CPC C09D 183/08; C09D 183/06; C09D 5/00

(57) ABSTRACT

A process for forming a fingerprint-resistant coating on a substrate comprising activating the substrate by exposure to a plasma, and then depositing on the activated substrate an alkyl silane, a POSS, or a mixture thereof.

### CROSS-REFERENCE TO RELATED APPLICATIONS

This application claims the benefit under 35 U.S.C. § 119(e) of U.S. Provisional Patent Application No. 62/676,052, filed May 24, 2018, the disclosure of which is incorporated by reference in its entirety.

### FIELD

The present disclosure relates, in exemplary embodiments, to coating compositions for coating a substrate to render fingerprints invisible or nearly invisible.

### BACKGROUND

A person naturally produces sebum (from the sebaceous gland) and other oils from the face and from fingertips. A person may deposit such oils on cell phone (or other article) display screens, such as glass (or a screen protector, typically a polymeric plastic), glass ceramic, metal oxide, Plexiglas or the like materials or surfaces. Often, such oils are visible and can reduce the quality of the images seen on the device, as well as contribute (with dirt, dust, etc.) to a reduced aesthetic appearance of the screen. Invisible fingerprint (“IFP”) coatings are generally oleophilic coatings that cause oils to be invisible, or nearly invisible, by causing the oils to spread along the screen surface. The oils may match the index of refraction of the screen material, e.g., glass, so that light passes through making it appear that there are no fingerprints. The fingerprints may still be present, one just cannot see them (at least not without scrutinizing the surface). Coatings and coating materials displaying IFP properties may need to be hydrophobic enough that the water beads up and evaporates. If the coating is too hydrophilic, then one may be able to see the fingerprint. However, if the coating is too hydrophobic, the surface may not exhibit adequate properties.

In contrast, “anti-fingerprint” (“AFP”) coatings are oleophobic coatings that resist wetting and can make fingerprints which do form more easily cleaned, but do not prevent formation of fingerprints or reduce the conspicuousness of fingerprints that do form. IFP coatings function in a different manner than AFP coatings.

It would be desirable to have a coating that can provide optically transparency, mechanically durability, and invisible fingerprint properties.

### SUMMARY

The following presents a simplified summary in order to provide a basic understanding of some aspects of various invention embodiments. The summary is not an extensive overview of the invention. It is intended neither to identify key or critical elements of the invention nor to delineate the scope of the invention. The following summary merely presents some concepts of the invention in a simplified form as a prelude to the more detailed description below.

The present disclosure relates, in exemplary embodiments to compositions and formulations for providing IFP coating. The present disclosure also relates to processes for forming a hydrophobic and oleophilic coating on a substrate, such as, but not limited to, a substrate made of a glass material, a ceramic or metal oxide surface.

In one exemplary embodiment, disclosed is a process for forming a fingerprint-resistant coating on a substrate, comprising (a) activating the substrate by exposing the substrate to a plasma of at least one gas selected from the group consisting of inert gases, N₂, O₂, and a mixture of at least two of the foregoing gases; and (b) a second deposition step, in which a formulation for a fingerprint-resistant coating comprising an alkylsilane, a POSS, or a mixture thereof is deposited.

In another exemplary embodiment, a formulation for a fingerprint-resistant coating comprises an alkylsilane, a POSS, or a mixture thereof is prepared in either a protic or an aprotic solvent and also comprising either an aqueous base or an aqueous acid.

In another exemplary embodiment, disclosed is a substrate obtained by the process described hereinabove, comprising a coating on a primer first layer, wherein a coating comprises a mixture of an alkyl silane, a hydrophilic OH-POSS, or a mixture thereof in either an aqueous acid or an aqueous base.

In another exemplary embodiment, disclosed is a composition for providing an invisible fingerprint coating, comprising an alkyl silane, a POSS, or a mixture thereof, having a water contact angle in a range of 70-90 degrees and a diiodomethane contact angle in a range of 30-40 degrees.

In another exemplary embodiment, disclosed is an invisible fingerprint coating material, comprising at least one alkyl silane material, a hydroxylated POSS, or a mixture thereof, the coating material having a water contact angle in a range of 75-85 degrees and a diiodomethane contact angle in a range of 30-40 degrees.

Other features will become apparent upon reading the following detailed description of certain exemplary embodiments, when taken in conjunction with the appended claims.

### BRIEF DESCRIPTION OF THE DRAWINGS

The drawings disclose exemplary embodiments or test results in which:

FIG. 1A is a photograph of a fingerprint placed between two pieces of Gorilla Tempered Glass showing two substrates: the substrate on the left is coated according to Example 1 and the substrate on the right is uncoated.

FIG. 1B is a detailed view of the photograph of FIG. 1A.

FIG. 2 is a chart showing chemical resistance of a substrate coated according to Example 5, before and after being rubbed with isopropyl alcohol.

FIG. 3 is a graph showing mechanical abrasion test results of a substrate coated according to Example 3, with water and diiodomethane oil.

### DETAILED DESCRIPTION

A fingerprint-resistant substrate in accordance with the present disclosure may comprise a surface coated with a fingerprint-resistant coating. Illustratively, the fingerprint-resistant substrate may be formed by a process comprising applying a formulation for a fingerprint-resistant coating onto the surface of the substrate. In some embodiments, the formulation for a fingerprint-resistant coating comprises an alkyl silane, a POSS, or a mixture thereof. As described herein, the fingerprint-resistant surface may have a delta E value of less than about 2 and provide abrasion resistance to the surface.

In exemplary embodiments, the substrate may be a glass screen, for example as used in electronic displays, such as, but not limited to, cell phone screens, computer monitors, television screens, touch screens, appliances, heads-up displays, glasses (e.g., eyeglasses and sunglasses), masks (e.g., welding masks), interior wall paints, and the like. In exemplary embodiments, the substrate may be used in appliance equipment and cosmetic finishes fields, for example decorative panels for appliances such as domestic electrical equipment (refrigerator doors, oven doors, display cases, etc.). The substrate may be made of glass (or a screen protector, typically a polymeric plastic), glass ceramic, metal oxide, Plexiglas or other material. In some embodiments, the substrate comprises a glass, a glass ceramic, a metal oxide, or a plastic.

It is to be understood that in the present disclosure, the term “invisible” includes not visible, invisible, nearly invisible or inconspicuous (e.g., not visible unless the surface is scrutinized). It is to be understood that “invisibility” also depends, to an extent, on the refraction of the light and on the way one views the surface. From some angles, a fingerprint may be invisible, while at other angles it may be discernable. The term “wettability” means the property whereby polar or non-polar liquids adhere to a substrate, forming an undesirable film, and also the tendency of a substrate to retain dust or dirt of all kinds, fingerprints, insects, etc.

In some embodiments, the presence of liquids, which may be laden with oil, can be critical in electronic display particularly for reducing the visibility of fingerprints on the surface. The wetting properties of a substrate can be categorized into hydro/oleophobic and hydro/oleophilic. A hydrophobic/oleophobic substrate means an oil (including organic liquids) and water repellent substrate. Usually, the contact angle of omniphobic surface is higher than about 60 degrees for hexadecane and about 90 degrees in the case of water in case of flat surface. Hydrophilic/oleophilic substrates mean oil and water are attracted to the surface. As such, the liquid will easily spread across the surface and have a low contact angle (less than about 50 degrees).

In one approach to achieve an invisible fingerprint coating, the contact angle of water and oil can be optimized such that the resulting liquids spread across the surface and the liquid on the surfaces matches the index of refraction from the glass substrate. In such cases, the light will pass through the fingerprint and make the visible effect of an invisible fingerprint. In order to achieve this contact angle, it was demonstrated that surfaces with hydrophobic properties and oleophilic properties were desired. In one approach to optimize the effect, it was found that that the water contact angle may be in the range of a bout 70-90 degrees or about 70-85 degrees and the diiodomethane contact angle may be in the range of about 20-40 degrees or about 25-40 degrees.

A feature of some compositions as disclosed herein is the use of a hydrophobic alkyl silane, an OH-POSS, or a mixture thereof. The alkyl silane provides hydrophobicity, but by itself can have a water contact angle of about 110 degrees and is too hydrophobic. Therefore, to reduce both the water and diiodomethane contact angles, in some embodiments, an additive is needed; however, the additive should provide the wettability and IFP properties when incorporated into the coating, and also be able to form a coating with the alkyl silane. Accordingly, existing additives were unlikely to be adequate. In some exemplary embodiments disclosed herein, OH-POSS is used as an additive because it is hydrophilic.

There are several benefits of incorporating an invisible fingerprint coating as described herein on a substrate, such as a glass substrate. Such a coating may allow the water droplets to slide off vertical or inclined surfaces and still be easily cleaned. The oleophilic surface of such coating may allow the fingerprint oils to spread across the surface and result in a liquid film instead of beaded-up oil. The combination of hydrophobicity and oleophilicity tuned, in exemplary embodiments, to a specific contact angle of at least about 70 degrees or at least about 80 degrees with water and less than about 40 degrees with diiodomethane can maximize the optical transparency or invisibility of fingerprint. Such coatings can demonstrate self-healing properties due to free-floating hydrophilic additives based in a hydrophobic coating, thereby reducing degradation over time.

Agents known for imparting invisible fingerprint properties that can be used in the form of a coating layer on glazing (substrate) include, but are not limited to, alkylsilanes, hydroxyl terminated T8 POSS nanoparticles, or mixtures thereof in acidic or alkaline solution. As described herein, a coating layer may be obtained by applying a solution containing an alkyl silane material and an OH-POSS in an aqueous or nonaqueous acidic or basic solvent to the surface of a substrate.

In some embodiments, the alkylsilane is bifunctional. Illustrative bifunctional alkylsilanes include haloalkyl silanes, bisalkyl silanes, bisalkoxy silanes, aminoalkyl silanes, hydroxyalkyl silanes, and phosphatealkyl silanes.

Illustrative bisalkyl silanes include bis triethoxy octyl silane and bis (trimethoxysilyl) 4-oxa-8-azundecan-6-ol.

Illustrative haloalkyl silanes include chloroundecyl silane and chlorohexyl silane.

Illustrative aminoalkyl silanes include aminoundecyl silane, N-2-aminoethyl-11-aminoundecyl tritehoxy silane, and N-6-aminohexyl aminomethyl triethoxy silane.

Illustrative hydroxyalkyl silanes include OH-decyl triethoxy silane.

Illustrative phosphatealkyl silanes include phosphate undecyl triethoxy silane.

“Self-healing” materials are those that have the ability to repair damage caused by mechanical use over time. Hydroxyl T8-POSS is a nanoparticle-based structure whose end terminals are hydrophilic and oleophilic that lower the repellency of the alkyl silane. Nanoparticles formed by the exemplary methods disclosed herein can be distributed in a generally uniform manner in the polymer matrix. These nanoparticles will float to the surface of the polymer matrix when damaged and demonstrate self-healing abilities.

As described herein, in some embodiments a fingerprint-resistant substrate comprises a substrate comprising a surface, and a fingerprint-resistant coating on the surface. Illustratively, the fingerprint-resistant surface may have a delta E of less than 2.

Illustratively, the substrate may be may be made of glass, a polymer, glass ceramic, metal oxide, Plexiglas or other material.

Delta E of the fingerprint-resistant surface is a measured difference between clean, or virgin, glass and fingerprinted glass, as described in the Examples. Illustratively, the lower the delta E the more invisible the fingerprints are on the surface. Delta E can also be measured after wiping the surface to determine how cleanly the fingerprint is removed. In some embodiments, the delta E of the fingerprint-resistant surface may be less than about 3, less than about 2, less than about 1, less than about 0.8, or less than about 0.5. In some embodiments, the delta E of the fingerprint-resistant surface is about 0.05, about 0.1, about 0.2, about 0.3, about 0.4, about 0.5, about 0.6, about 0.7, about 0.8, about 0.9, about 1, about 1.1, about 1.2, about 1.3, about 1.4, about 1.5, about 1.6, about 1.7, about 1.8, about 1.9, about 2, about 2.2, about 2.5, or about 3. In a first series of ranges, the delta E of the fingerprint-resistant surface is in a range of about 0.1 to about 2, about 0.1 to about 1.5, about 0.1 to about 1, about 0.2 to about 1, about 0.3 to about 1, or about 0.4 to about 0.9. In a second series of ranges, the delta E may be about 0.05 to about 1.2, about 0.05 to about 0.9, about 0.05 to about 0.8, or about 0.05 to about 0.5.

In some embodiments, the fingerprint-resistant surface has an initial oil angle using diodomethane (CH₂12) as measured according to the Examples. In some embodiments, the initial oil angle is less than about 60°, less than about 50°, less than about 45°, less than about 40°, less than about 35°, or less than about 30°. In some embodiments, the initial oil angle of the fingerprint-resistant surface is about 20°, about 21°, about 22°, about 23°, about 24°, about 25°, about 26°, about 27°, about 28°, about 29°, about 30°, about 31°, about 32°, about 33°, about 34°, about 35°, about 37°, about 40°, about 45°, about 50°, about 55°, or about 60°. In some embodiments, the initial oil angle of the fingerprint-resistant surface may be in a range of about 20° to about 60°, about 20° to about 50°, about 20° to about 40°, about 20° to about 35°, or about 20° to about 30°.

In some embodiments, the fingerprint-resistant surface has an initial water angle as measured according to the Examples. In some embodiments, the initial water angle is greater than about 60°, greater than about 65°, greater than about 75°, greater than about 80°, greater than about 90°, or greater than about 100°. In some embodiments, the initial water angle of the fingerprint-resistant surface is about 60°, about 65°, about 70°, about 75°, about 76°, about 77°, about 78°, about 79°, about 80°, about 81°, about 82°, about 83°, about 84°, about 85°, about 86°, about 87°, about 88°, about 89°, about 90°, about 95°, about 100°, about 105°, about 110°, or about 115°. In some embodiments, the initial water angle of the fingerprint-resistant surface may be in a range of about 60° to about 115°, about 60° to about 110°, about 70° to about 110°, about 70° to about 95°, about 70° to about 90°, or about 75° to about 95°.

In some embodiments, the fingerprint-resistant surface has a particular abrasion resistance as measured by the water angle after a certain number of cycles, as described in the Examples. Illustratively, the fingerprint-resistant surface may have a particular water angle after enduring about 1,500 cycles, about 3,000 cycles, or about 4,500 cycles, as described in the Examples. Illustratively, the post-abrasion water angle may be greater than about 40°, greater than about 50°, greater than about 55°, or greater than about 60°. In some embodiments, the post-abrasion water angle of the fingerprint-resistant surface is about 40°, about 50°, about 55°, about 60°, about 65°, about 70°, about 75°, about 80°, or about 85° after about 1,500 cycles, about 3,000 cycles, or about 4,500 cycles. In some embodiments, the post-abrasion water angle of the fingerprint-resistant surface may be in a range of about 40° to about 85°, about 50° to about 85°, about 50° to about 80°, or about 60° to about 80° after about 1,500 cycles, about 3,000 cycles, or about 4,500 cycles.

In illustrative embodiments, the fingerprint-resistant surface has a particular coefficient of friction. In some embodiments, the coefficient of friction is less than about 0.2 or less than about 0.15. In some embodiments, the coefficient of friction is about 0.08, about 0.09, about 0.1, about 0.11, about 0.12, about 0.13, about 0.14, or about 0.15. In some embodiments, the coefficient of friction is in a range of about 0.08 to about 0.15 or about 0.09 to about 0.13.

In some embodiments, the fingerprint-resistant surface is formed by applying a formulation for a fingerprint-resistant coating onto a substrate. In some embodiments, the formulation for a fingerprint-resistant coating comprises an alkyl silane, a POSS, or a mixture thereof. In some embodiments, the formulation comprises a solvent.

In some embodiments, the alkyl silane is of the formula

(R^{A})₃SiR^{B},

wherein each R^{A} is independently —OC₁-C₆ alkyl, —OC₂-C₆ alkenyl, or —OC₂-C₆ alkynyl; and R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, —C(O)OR¹, —C(O)OC₁-C₂₀—PO₃H₂, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, —NH₂, —NH(C₁-C₆ alkyl), —N(H)C₁-C₆ alkyl-NH₂, —N(H)C₁-C₆ alkyl-Si(˜OC₁-C₆ alkyl)₃, —N(R¹)C₁-C₆ alkyl-N(R¹)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or —Si(˜OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and wherein R¹ is independently deuterium, C₁-C₆ alkyl, C₂-C₆alkenyl, C₂-C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy. In some embodiments, R^{A} is —OC₁-C₆ alkyl. In some embodiments, R^{B} is C₁₀-C₂₀ alkyl, C₁₀-C₂₀ alkenyl, or C₁₀-C₂₀ alkynl wherein each hydrogen atom in C₁₀-C₂₀ alkyl, C₁₀-C₂₀ alkenyl, or C₁₀-C₂₀ alkynl is optionally substituted with halo. In some embodiments, R^{B} is not a halo-substituted n-octyltriethoxysilane or a halo-substituted C₁-C₆ alkyl.

In some embodiments, R^{B} is C₁-C₂₀ alkyl, C₆-C₂₀ alkyl, or C₁₀-C₂₀ alkyl wherein each hydrogen atom C₁-C₂₀ alky, C₆-C₂₀ alkyl, or C₁₀-C₂₀ alkyl is optionally substituted. In some embodiments, each hydrogen atom may be independently optionally substituted by halogen, —OH, —CN, —OR¹, —CO₂H, —NH₂, —NH(C₁-C₆ alkyl), —N(C₁-C₆ alkyl)₂, —P(C₁-C₆ alkyl)₂, —P(O)(C₁-C₆ alkyl)₂, —PO₃H₂, wherein R¹ is independently deuterium or —C₁-C₆alkyl-O—C₁-C₆ alkyl. Illustratively, the halogen may be chloro, bromo, or iodo. In some embodiments, the alkyl silane comprises a halogen but does not comprise a fluoro. In some embodiments, the alkyl silane does not comprise a PEG group.

In some embodiments, the alkyl silane may be a particular concentration in the formulation for a fingerprint-resistant coating. In some embodiments, the alkyl silane is at a concentration of about 1 g/l to about 6 g/l, about 1 g/l to about 5 g/l, about 2 g/l to about 5 g/l, or about 3 g/l to about 5 g/l. In some embodiments, the alkyl silane may be at a concentration of about 1 g/l, about 2 g/l, about 3 g/l, about 3.25 g/l, about 3.5 g/l, about 3.75 g/l, about 4 g/l, about 4.25 g/l, about 4.5 g/l, about 5 g/l, about 5.5 g/l, or about 6 g/l.

In some embodiments, alkyl silane is selected from group consisting of (chloroundecyl)(triethoxy) silane, (chloroundecyl)(trimethoxy)silane, (chlorohexyl)(triethoxy)silane, (chlorohexyl)(trimethoxy)silane, 11-(2-methoxyethoxy)undecyltrimethoxyslane, (aminoundecyl)(triethoxy) silane, (aminoundecyl)(trimethoxy)silane, (hydoxydecyl)(triethoxy) silane, (hydoxydecyl)(trimethoxy) silane, (11-undecylinicacid)(triethoxy)silane, (hydroxyheptyl)(triethoxy) silane, (hydroxyundecyl)(triethoxy)silane, and (11-phosphoundecyl)(triethoxy)silane.

In some embodiments, the POSS is of the formula

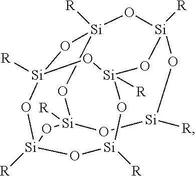

wherein R is —C₁-C₆ alkyl, -A^{E}-O—B^{F}-C^{G}-O-D^{H}, or —O—Si(C₁-C₆ alkyl)₃, wherein A is C₁-C₆ alkyl, B is —C₁-C₆ alkyl-O—, C is C₁-C₆ alkyl, D is C₁-C₆ alkyl, O is oxygen, each of E, G, and H is at least 1, and F is an integer from 5 to 12, and wherein each hydrogen atom in —C₁-C₆ alkyl is independently optionally substituted with deuterium, halogen, —OH, —CN, —OR², —OC₁-C₆ alkyl, —NH₂, —NH(C₁-C₆ alkyl), —NH(C₁-C₆ alkyl), —N(H)C₁-C₆ alkyl-NH₂, —N(C₁-C₆ alkyl)₂, —P(C₁-C₆ alkyl)₂, —P(O)(C₁-C₆ alkyl)₂, or —OPO₃H; and wherein R² is independently deuterium, C₂-C₆ alkenyl, C₂-C₆ alkynyl, C₃-C₆ cycloalkyl, or —C₁-C₆ alkyl-O—C₁-C₆ alkyl. In some embodiments, R is-A^{E}-O—B^{F}—C^{G}—O-D^{H} or —O-Si(C₁-C₆ alkyl)₃. In some embodiments, R is —A^{E}-O—B^{F}-C^{G}-O-D^{H}. In some embodiments, R is —(CH₂)₃O(CH₂CH₂O)₉CH₂CH₂OCH₃. In some embodiments, R is —O—Si(CH₂)₂CH₂CH₂CH₂OH. Exemplary POSS are made according to Example 1 in US Patent Application Publication No. 2017/0349785, or may be purchased from Sigma Aldrich under the CAS number 288290-32-4. In some embodiments, R is C₁-C₆ alkyl or —O-Si—(C₁-C₆ alkyl)₃ and at least one C₁-C₆ alkyl is substituted with at least one hydroxy.

In some embodiments, the POSS may be a particular concentration in the formulation for a fingerprint-resistant coating. In some embodiments, the POSS is at a concentration of about 10 mg/l to about 1 g/l, about 10 mg/l to about 800 mg/l, about 20 mg/l to about 800 mg/l, about 50 mg/l to about 500 mg/l, or about 50 mg/l to about 250 mg/l. In some embodiments, POSS may be at a concentration of about 10 mg/l, about 50 mg/l, about 75 mg/l, about 100 mg/l, about 125 mg/l, about 150 mg/l, about 200 mg/l, about 300 mg/l, about 400 mg/l, about 500 mg/l, about 600 mg/l, about 700 mg/l, about 800 mg/l, or about 1 g/l.

In some embodiments, the composition includes a siloxane. In some embodiments, the alkoxy silane is a trialkoxysilyl siloxane. In some embodiments, the dialkyl siloxane is formed by contacting a vinyl-terminated dialkyl siloxane with a compound of formula (R^{c}O)₃SiH, where R^{C} is an alkyl group. In some embodiments, the siloxane is an alkyl siloxane. In some embodiments, the alkoxy siloxane is an alkoxy polydimethylsiloxane. In some embodiments, the alkoxy siloxane is a trialkoxysilyl polydimethylsiloxane. In some embodiments, the siloxane, such as a trialkoxysilyl polydimethylsiloxane, has a molecular weight of at least about 2,000 Da, at least about 3,000 Da, or at least about 4,000 Da. In some embodiments, the siloxane, such as a trialkoxysilyl polydimethylsiloxane, has a molecular weight of less than about 8,000 Da, less than about 6,000 Da, or less than about 5,500 Da.

In some embodiments, the siloxane, such as a trialkoxysilyl polydimethylsiloxane, may be a particular concentration in the formulation for a fingerprint-resistant coating. In some embodiments, the siloxane, such as a trialkoxysilyl polydimethylsiloxane, is at a concentration of about 0.01 mg/l to about 5 mg/l, about 0.1 mg/l to about 3 mg/l, or about 0.2 mg/l to about 2 mg/l. In some embodiments, the siloxane, such as a trialkoxysilyl polydimethylsiloxane, may be at a concentration of about 0.01 mg/l, about 0.1 mg/l, about 0.2 mg/l, about 0.3 mg/l, about 0.4 mg/l, about 0.5 mg/l, about 0.6 mg/l, about 0.7 mg/l, about 1 mg/l, about 2 mg/l, about 3 mg/l, about 4 mg/l, or about 5 mg/l. In some embodiments, the siloxane, such as a trialkoxysilyl polydimethylsiloxane is present at about 0.375 mg/l.

In some embodiments, the composition comprises ratio by weight of an alkyl silane and a siloxane. In some embodiments, the ratio by weight is at least about 5:1 or at least 25:1 alkyl silane:siloxane. In some embodiments, the ratio by weight is about 5:1 to about 50:1, about 5:1 to about 40:1, or about 5:1 to about 20:1 alkyl silane:siloxane. In some embodiments, the ratio is about 10:1 alkyl silane:siloxane. These illustrative ratios apply equally if the siloxane is a trialkoxysilyl polydimethylsiloxane.

In some embodiments, the formulation for a fingerprint-resistant coating comprises a solvent. In some embodiments, the solvent comprises water, an alcohol, or a mixture thereof. In some embodiments, the alcohol is a C₁-C₆ alkyl-OH. In some embodiments, the solvent is methanol, ethanol, propanol, butanol, pentanol, hexanol, or a combination thereof.

In some embodiments, the solvent is at an acidic pH. In some embodiments, the solvent is at a pH of about 1 to about 7. In some embodiments, the pH is about 1, about 2, about 3, about 4, about 5, about 6, or about 7. In some embodiments, the pH is about 1 to about 6, about 2 to about 6, or about 2 to about 5. Illustratively, the solvent can be acidified with an acid. In some embodiments, the acid is nitric acid, although other acids capable of accomplishing the desired pH can be used.

Illustratively, the formulation for a fingerprint-resistant surface can be applied to a substrate to form the fingerprint-resistant surface by a particular method. In some embodiments, a method for forming a fingerprint-resistant coating on a substrate comprises a step of applying. In some embodiments, the method comprises a step of curing. In some embodiments, the method comprises a step of applying and a step of curing.

In some embodiments, the step of applying may applying is performed by dipping, wiping, or spraying the formulation for a fingerprint-resistant coating onto the surface of the substrate.

In some embodiments, the step of applying is performed by dipping, wiping, spraying the formulation for a fingerprint-resistant coating onto the surface of the substrate, chemical vapor deposition (CVD), or physical vapor deposition (PVD).

In some embodiments, the process for forming a fingerprint-resistant coating on a substrate comprises applying by PVD a formulation for a fingerprint-resistant coating to a surface of the substrate. Illustratively, the step of applying can be performed by thermal evaporation. In some embodiments, the process comprises curing the formulation on the surface of the substrate. In some embodiments, the process comprises a step of cleaning the surface of the substrate. In some embodiments, the step of cleaning is performed before the step of applying. In some embodiments, the formulation is in the form of a pellet. In some embodiments, the process comprises a step of forming the pellet of the formulation. In some illustrative embodiments, the step of forming the pellet comprises contacting a steel wool or copper foam with the hydrolysate.

Illustratively, the step of curing can be performed at an elevated temperature or at room temperature. In some embodiments, the step of curing is performed at room temperature. In some embodiments, the step of curing is performed at least about 70° C., at least about 80° C., at least about 90° C., or at least about 100° C.

In some embodiments, the step of curing is performed for a duration of time to allow the formulation to cure and may be dependent on the temperature used for the step of curing. In some embodiments, the step of curing is performed overnight. In some embodiments, the step of curing is performed for at least about 5 minutes, at least about 10 minutes, or at least about 30 minutes. In some embodiments, the step of curing is performed for about 10 minutes, about 1 hour, about 2 hours, about 3 hours, about 4 hours, or about 6 hours. In some embodiments, the step of curing is performed at a temperature of about 120° C. for about 10 minutes. In some embodiments, the step of curing is performed at a temperature of about 80° C. for about 1 hour. In some embodiments, the step of curing is performed at room temperature overnight.

In some embodiments, the method comprises step of activating the surface of the substrate by exposing the surface to a plasma of at least one gas selected from the group consisting of inert gases, N₂, O₂, and a mixture of at least two of the foregoing gases.

One of the more significant problems with optically transparent substrates and coatings is mechanical abrasion, which degrades, wears away, or diminishes the coating thickness, transparency, or effectiveness. Abrasion occurs to a greater or lesser extent during substrate handling by the user, such as by rubbing with a cloth to remove fingerprints and dirt, which is periodically necessary in particular for restoring satisfactory visibility through a transparent substrate. Degradation may also result from exposure to ultraviolet radiation, heat, cold, chemical, salt or other corrosive material, dirt, other abrasive material, or other environmental elements, conditions, or materials.

Such self-healing and abrasion resistance performance typically makes it possible for the substrates to meet the specifications imposed at the present time by the electronic industry more effectively, both in terms of abrasion resistance, UV resistance, and salt corrosion resistance.

In exemplary embodiments, suitable coatings may have a water contact angle between 70 and 90 degrees or between 75 and 85 degrees. In exemplary embodiments, suitable coatings may have a diiodomethane contact angle between 30 and 40 degrees.

According to one exemplary embodiment, an exemplary process is disclosed for providing a coating on a substrate, such as one formed of a glass material, a ceramic, or a metal oxide, the process comprising the following steps.

First, a substrate is activated by exposure of the substrate surface to a plasma of a gas selected from the inert gases of the Ar or He type, the gases N₂, O₂, or H₂O, or a mixture of two or more of the foregoing. According to one exemplary embodiment, this activation step is carried out by exposing the substrate to a plasma of a gas mixture containing H₂O. The activation step increases the hydroxyl density on the surface of the substrate, thereby increasing the bonding density of the SAM.

Second, a hydrophobic coating comprising at least one alkyl monolayer and a T8 hydroxyl polyhedral oligomeric silsesquioxane (Hydroxyl-POSS) is formed. In exemplary embodiments, the alkyl monolayer is either an alkylsilane (AS) or alkylthiol (AT). In other exemplary embodiments, the alkyl monolayer comprises a bifunctional silane. This is then mixed with a protic or an aprotic solvent containing either an aqueous base or acid.

Third, an optional hydrophobic coating is deposited on the substrate.

Fourth, an formulation for a fingerprint-resistant coating comprising an alkyl silane, a POSS, or a mixture thereof is prepared in either a protic or an aprotic solvent containing either an aqueous base or acid.

Typically, the formulation for a fingerprint-resistant coating is deposited by dip, spray, and thermal CVD (chemical vapor deposition) under conditions enabling a RMS (root mean square) surface roughness of between 5 and 100 nm to be obtained. In exemplary embodiments, a RMS (root mean square) surface roughness of between 5 and 10 nm can be obtained.

Glazed substrates thus obtained are optically transparent, resistant to mechanical abrasion and other mechanical impact affects, and is self-healing. For the purposes of the present disclosure, “optically transparent” means optically neutral to the substrate (for example, glass), i.e., the transmission or haze of pre-treated glass is not materially changed.

According to one exemplary method, the step of depositing the coating is carried out using a solution obtained from a mixture of an either alkylsilane (AS) of formula, hydroxyl terminated T8 polyhedral oligomeric silsesquioxane, and either an aqueous acid or an aqueous base. In some embodiments, the alkyl silane is of the formula

H₃C—(CH₂)ₙ—Si(X)₃₋ₚ(R)ₚ

wherein n=0 to 15, preferably n=3 to 5; or n=10 to 20; wherein p=0, or 2; or p=0 or 1; yet in another exemplary embodiment, p=0. In some embodiments, R is an alkyl group or a hydrogen atom; and, X is a hydrolysable group, such as, but not limited to, a halide group or an alkoxy group. In some embodiments, the POSS has the structure

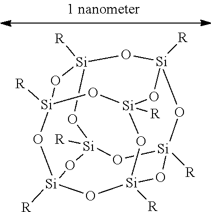

wherein R is OH—(CH₂)ₙ, n=0 to 5, preferably, n=1.

A feature of exemplary embodiments of the presently disclosed composition is the balancing of the relative amounts of alkyl silane and the OH-POSS. A traditional alkyl silane will provide materials that are too hydrophobic and oleophobic to serve adequately as an invisible fingerprint coating. Pure glass is hydrophilic and oleophobic (WCA at about 30 degrees, and diiodomethane at about 40-45 degrees). Regarding the substitution on the POSS structure, generally, the more hydroxylation there is, the more hydrophilic the structure will be. It is important to have the right level of hydroxylation to avoid too high or too low a WCA, which would result in inadequate properties to provide invisible fingerprint functionality. Too much OH-POSS and the material becomes hydrophilic and does not demonstrate the desired properties. Too little OH-POSS results in the material being too hydrophobic/oleophobic to work. As such, the wettability needs to be tuned with respect to the particular OH-POSS composition and the intended use (e.g., substrate) to adequately provide invisible fingerprint properties. Coated surfaces having a water contact angle in a range of 75-85 degrees and a diiodomethane contact angle in a range of 30-40 degrees demonstrated excellent invisibility properties.

In alternative exemplary embodiments, other non-fluorinated hydrophobic materials instead of OH-POSS may be used. It is also possible that other hydrophilic POSS materials may be used, such as, but not limited to, PEGylated-POSS, amine-substituted POSS, carboxylic acid-substituted POSS, and the like.

In another exemplary embodiment, a coating made according to the methods disclosed herein had a water contact angle of 80 degrees and a diiodomethane contact angle of 30 degrees and displayed excellent invisible fingerprint properties.

The present disclosure also relates to an omniphobic coating comprising or formed by a substrate as described herein, this coating being in particular used as glazing for various vehicle surfaces or for buildings.

Aqueous acid or base may be required to assist nucleophilic reaction of alkyl silane. In exemplary embodiments, the acid may have a pH in the range of 1-3. In exemplary embodiments, the acid may be a composition, such as, but not limited to, ascorbic acid, citric acid, salicylic acid, acetic acid, hydrochloric acid, oxalic acid, phosphoric acid, sulfuric acid, or the like. In exemplary embodiments, the base may have a pH in the range of 11-14. In exemplary embodiments, the base may be a composition, such as, but not limited to, ammonium hydroxide, sodium bicarbonate, sodium carbonate, sodium hydroxide, potassium hydroxide, or the like. A low pH acid or high pH base as described hereinabove is used because a deprotonation of the OH occurs on the substrate (e.g., glass) surface to become O—, which is more reactive as a nucleophile than OH, thereby increasing the bonding density of the SAM, which has the leaving group.

According to exemplary embodiments, a formulation for a fingerprint-resistant coating comprising an alkyl silane, an OH-POSS, or a mixture thereof, and an aqueous base may be deposited by any appropriate deposition technique known to those skilled in the art, as described hereinabove.

The present disclosure also provides a glass, ceramic or metal oxide substrate provided with an invisible fingerprint coating that can be obtained by process according to one of the above exemplary embodiments, comprising: An alkyl silane and an OH-POSS material in aqueous base or acid, i.e., essentially, or exclusively, consisting of an invisible fingerprint layer, the surface of which has a surface roughness of greater than 5 nm and has been activated by treatment with a plasma of a gas chosen from the noble gases of the Ar or He type, the gases N₂ or O₂, or by a plasma of a mixture of at least two of the foregoing gases, preferably under conditions not modifying or substantially not modifying the surface roughness; and an alkyl silane and an OH-POSS, comprising an invisible fingerprint coating is assisted by aqueous base or acid to be bound on the substrate.

In exemplary embodiments, the substrate is obtained by carrying out an activation step activated by means of a plasma of a gas mixture containing H₂O and at least one gas selected from the group consisting of Ar, He and N₂.

In exemplary embodiments, the thickness of the invisible fingerprint layer is between 10 and 500 nm. In other exemplary embodiments, the thickness of the invisible fingerprint layer is between 20 and 100 nm.

In exemplary embodiments, the RMS roughness of the omniphobic layer is less than 10 nm. In other exemplary embodiments, the RMS roughness of the omniphobic layer is between 5 and 10 nm.

A feature of the coating materials disclosed in exemplary embodiments is the ability to form a coating on a surface and have a water contact angle between 70-90 degrees or 75-85 degrees and a diiodomethane contact angle between 30-40 degrees.

In some embodiments, the step of contacting further contains an alkoxy siloxane. In some embodiments, the alkoxy silane is a trialkoxysilyl siloxane. In some embodiments, the dialkyl siloxane is formed by contacting a vinyl-terminated dialkyl siloxane with a compound of formula (R^{c}O)₃SiH, where R^{c} is an alkyl group. In some embodiments, the siloxane is an alkyl siloxane. In some embodiments, the alkoxy siloxane is an alkoxy polydimethylsiloxane. In some embodiments, the alkoxy siloxane is a trialkoxysilyl polydimethylsiloxane.

In illustrative embodiments, the trialkoxysilyl siloxane is formed by reacting a trialkoxy silane with a commercially available siloxane in the presence of a catalyst. Illustrative siloxanes include polydimethyl siloxane, available from Gelest. In some embodiments, the catalyst is a platinum catalyst.

Although only a number of exemplary embodiments have been described in detail above, those skilled in the art will readily appreciate that many modifications are possible in the exemplary embodiments without materially departing from the novel teachings and advantages. The following numbered clauses include embodiments that are contemplated and non-limiting:

Clause 1. A fingerprint-resistant substrate made by a process comprising,

applying a formulation for a fingerprint-resistant coating onto a surface of a substrate,

wherein the fingerprint-resistant surface has a delta E of less than 2.

Clause 2. The fingerprint-resistant substrate of any of the preceding clauses or combination of clauses, wherein the fingerprint-resistant surface has an initial oil angle of less than about 40° and an initial water angle of greater than about 65°.

Clause 3. The fingerprint-resistant substrate of any of the preceding clauses or combination of clauses, wherein the formulation for a fingerprint-resistant coating comprises an alkyl silane of the formula

(R^{A})₃SiR^{B},

wherein each R^{A} is independently —OC₁-C₆ alkyl, —OC₂-C₆ alkenyl, or —OC₂-C₆ alkynyl;

R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, —C(O)OR¹, —C(O)OC₁-C₂₀—PO₃H₂, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, —NH₂, —NH(C₁-C₆ alkyl), —N(H)C₁-C₆ alkyl-NH₂, —N(H)C₁-C₆ alkyl-Si(˜OC₁-C₆ alkyl)₃, —N(R¹)C₁-C₆ alkyl-N(R)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or —Si(˜OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and

R¹ is independently deuterium, C₁-C₆ alkyl, C₂-C₆ alkenyl, C₂-C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

Clause 4. The fingerprint-resistant substrate of any of the preceding clauses or combination of clauses, wherein R^{A} is —OC₁-C₆ alkyl.

Clause 5. The fingerprint-resistant substrate of any of the preceding clauses or combination of clauses, wherein R^{B} is C₆-C₂₀ alkyl or C₁₀-C₂₀ alkyl.

Clause 6. The fingerprint-resistant substrate of any of the preceding clauses or combination of clauses, wherein R^{B} is C₆-C₂₀ alkyl or C₁₀-C₂₀ alkyl and each hydrogen atom in C₆-C₂₀ alkyl or C₁₀-C₂₀ is independently optionally substituted by halogen, —OH, —CN, —OR¹, —CO₂H, —NH₂, —NH(C₁-C₆ alkyl), —N(C₁-C₆ alkyl)₂, —P(C₁-C₆ alkyl)₂, —P(O)(C₁-C₆ alkyl)₂, or —PO₃H₂, wherein R¹ is independently deuterium or —C₁-C₆ alkyl-O—C₁-C₆ alkyl.

Clause 7. The fingerprint-resistant substrate of any of the preceding clauses or combination of clauses, wherein the alkyl silane is selected from the group consisting of (chloroundecyl)(triethoxy) silane, (chloroundecyl)(trimethoxy)silane, (chlorohexyl)(triethoxy)silane, (chlorohexyl)(trimethoxy)silane, 11-(2-methoxyethoxy)undecyltrimethoxyslane, (aminoundecyl)(triethoxy) silane, (aminoundecyl)(trimethoxy)silane, (hydoxydecyl)(triethoxy) silane, (hydoxydecyl)(trimethoxy) silane, (11-undecylinicacid)(triethoxy)silane, (hydroxyheptyl)(triethoxy) silane, (hydroxyundecyl)(triethoxy)silane, and (11-phosphoundecyl)(triethoxy)silane.

Clause 8. The fingerprint-resistant substrate of any of the preceding clauses or combination of clauses, wherein the alkyl silane does not include a fluoro.

Clause 9. The fingerprint-resistant substrate of any of the preceding clauses or combination of clauses, wherein the formulation for a fingerprint-resistant coating comprises a POSS of the formula

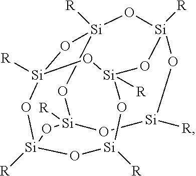

wherein R is —C₁-C₆ alkyl, -A^{E}-O—B^{F}-C^{G}-O-D^{H}, or —O-Si(C₁-C₆ alkyl)₃, wherein A is C₁-C₆alkyl, B is —C₁-C₆ alkyl-O—, C is C₁-C₆ alkyl, D is C₁-C₆ alkyl, O is oxygen, each of E, G, and H is at least 1, and F is an integer from 5 to 12, and wherein each hydrogen atom in —C₁-C₆ alkyl is independently optionally substituted with deuterium, halogen, —OH, —CN, —OR², —OC₁-C₆ alkyl, —NH₂, —NH(C₁-C₆ alkyl), —NH(C₁-C₆ alkyl), —N(H)C₁-C₆ alkyl-NH₂, —N(C₁-C₆ alkyl)₂, —P(C₁-C₆ alkyl)₂, —P(O)(C₁-C₆ alkyl)₂, or —OPO₃H; and

wherein R² is independently deuterium, C₂-C₆ alkenyl, C₂-C₆ alkynyl, C₃-C₆ cycloalkyl, or —C₁-C₆ alkyl-O—C₁-C₆ alkyl.

Clause 10. The fingerprint-resistant substrate of any of the preceding clauses or combination of clauses, wherein R is -A^{E}-O—B^{F}—C^{G}—O-D^{H} or —O—Si(C₁-C₆ alkyl)₃.

Clause 11. The fingerprint-resistant substrate of any of the preceding clauses or combination of clauses, wherein R-A^{E}-O—B^{F}—C^{G}—O-D^{H}.

Clause 12. The fingerprint-resistant substrate of any of the preceding clauses or combination of clauses, wherein R is —(CH₂)₃O(CH₂CH₂O)₉CH₂CH₂OCH₃.

Clause 13. The fingerprint-resistant substrate of any of the preceding clauses or combination of clauses, wherein the fingerprint-resistant substrate has a coefficient of friction less than about 0.2.

Clause 14. The fingerprint-resistant substrate of any of the preceding clauses or combination of clauses, wherein the fingerprint-resistant substrate has a coefficient of friction less than about 0.13.

Clause 15. The fingerprint-resistant substrate of any of the preceding clauses or combination of clauses, wherein the substrate is comprises at least one material selected from the group consisting of glass, metal oxide, and acrylic polymer.

Clause 16. The fingerprint-resistant substrate of any of the preceding clauses or combination of clauses, wherein the fingerprint-resistant substrate has an initial oil angle of at least less than about 50°.

Clause 17. The fingerprint-resistant substrate of any of the preceding clauses or combination of clauses, wherein the fingerprint-resistant substrate has an initial oil angle of at least less than about 45°.

Clause 18. The fingerprint-resistant substrate of any of the preceding clauses or combination of clauses, wherein the fingerprint-resistant substrate has an initial oil angle of at least less than about 35°.

Clause 19. The fingerprint-resistant substrate of any of the preceding clauses or combination of clauses, wherein the fingerprint-resistant substrate has an initial water angle of greater than about 65°.

Clause 20. The fingerprint-resistant substrate of any of the preceding clauses or combination of clauses, wherein the fingerprint-resistant substrate has an initial water angle of about 70° to about 90°.

Clause 21. The fingerprint-resistant substrate of any of the preceding clauses or combination of clauses, wherein the fingerprint-resistant substrate is substantially free of fluoride.

Clause 22. The fingerprint-resistant substrate of any of the preceding clauses or combination of clauses, wherein the delta E is less than about 0.7.

Clause 23. A formulation for a fingerprint-resistant coating, the formulation comprising

an alkyl silane,

a POSS, and

a solvent.

Clause 24. The formulation of any of clause 23, wherein the alkyl silane is of the formula

(R^{A})₃SiR^{B},

wherein each R^{A} is independently —OC₁-C₆ alkyl, —OC₂-C₆ alkenyl, or —OC₂-C₆ alkynyl;

R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, —C(O)OR¹, —C(O)OC₁-C₂₀—PO₃H₂, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, —NH₂, —NH(C₁-C₆ alkyl), —N(H)C₁-C₆ alkyl-NH₂, —N(H)C₁-C₆ alkyl-Si(˜OC₁-C₆ alkyl)₃, —N(R¹)C₁-C₆ alkyl-N(R¹)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or —Si(˜OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and

R¹ is independently deuterium, C₁-C₆ alkyl, C₂-C₆ alkenyl, C₂-C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

Clause 25. The formulation of any of one of or combination of clauses 23-24, wherein R^{A} is —OC₁-C₆ alkyl.

Clause 26. The formulation of any of one of or combination of clauses 23-25, wherein R^{B} is C₆-C₂₀ alkyl or C₁₀-C₂₀ alkyl.

Clause 27. The formulation any of one of or combination of clauses 23-26, wherein R^{B} is C₆-C₂₀ alkyl or C₁₀-C₂₀ alkyl and each hydrogen atom in C₆-C₂₀ alkyl or C₁₀-C₂₀ is independently optionally substituted by halogen, —OH, —CN, —OR¹, —CO₂H, —NH₂, —NH(C₁-C₆ alkyl), —N(C₁-C₆ alkyl)₂, —P(C₁-C₆ alkyl)₂, —P(O)(C₁-C₆ alkyl)₂, —PO₃H₂, wherein R¹ is independently deuterium or —C₁-C₆ alkyl-O—C₁-C₆alkyl.

Clause 28. The formulation of any of one of or combination of clauses 23-27, wherein the alkyl silane is selected from the group consisting of (chloroundecyl)(triethoxy)silane, (chloroundecyl)(trimethoxy)silane, (chlorohexyl)(triethoxy)silane, (chlorohexyl)(trimethoxy)silane, 11-(2-methoxyethoxy)undecyltrimethoxyslane, (aminoundecyl)(triethoxy)silane, (aminoundecyl)(trimethoxy)silane, (hydoxydecyl)(triethoxy) silane, (hydoxydecyl)(trimethoxy)silane, (11-undecylinicacid)(triethoxy) silane, (hydroxyheptyl)(triethoxy) silane, (hydroxyundecyl)(triethoxy)silane, and (11-phosphoundecyl)(triethoxy)silane.

Clause 29. The formulation of any of one of or combination of clauses 23-28, wherein the POSS is of the formula

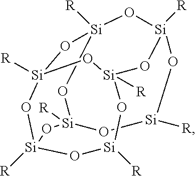

wherein R is —C₁-C₆ alkyl, -A^{E}-O—B^{F}-C^{G}-O-D^{H}, or —O-Si(C₁-C₆ alkyl)₃, wherein A is C₁-C₆ alkyl, B is —C₁-C₆ alkyl-O—, C is C₁-C₆ alkyl, D is C₁-C₆ alkyl, O is oxygen, each of E, G, and H is at least 1, and F is an integer from 5 to 12, and wherein each hydrogen atom in —C₁-C₆ alkyl is independently optionally substituted with deuterium, halogen, —OH, —CN, —OR², —OC₁-C₆ alkyl, —NH₂, —NH(C₁-C₆ alkyl), —NH(C₁-C₆ alkyl), —N(H)C₁-C₆ alkyl-NH₂, —N(C₁-C₆ alkyl)₂, —P(C₁-C₆ alkyl)₂, —P(O)(C₁-C₆ alkyl)₂, or —OPO₃H; and

wherein R² is independently deuterium, C₂-C₆ alkenyl, C₂-C₆ alkynyl, C₃-C₆ cycloalkyl, or —C₁-C₆ alkyl-O—C₁-C₆ alkyl.

Clause 30. The formulation any of one of or combination of clauses 23-29, wherein R is-A^{E}-O—B^{F}—C^{G}—O-D^{H} or —O—Si(C₁-C₆ alkyl)₃.

Clause 31. The formulation of any of one of or combination of clauses 23-30, wherein R is -A^{E}-O—B^{F}—C^{G}—O-D^{H}.

Clause 32. The formulation of any of one of or combination of clauses 23-31, wherein R is —(CH₂)₃O(CH₂CH₂O)₉CH₂CH₂OCH₃.

Clause 33. The formulation of any of one of or combination of clauses 23-32, wherein the alkyl silane is at a concentration of about 1 g/l to about 6 g/L.

Clause 34. The formulation of any of one of or combination of clauses 23-34, wherein the concentration of the alkyl silane is about 2 g/l to about 5 g/l.

Clause 35. The formulation of any of one of or combination of clauses 23-34, wherein the POSS is at a concentration of about 50 mg/l to about 500 mg/l.

Clause 36. The formulation of any of one of or combination of clauses 23-35, wherein the concentration of the POSS is about 50 mg/; to about 250 mg/l.

Clause 37. The formulation of any of one of or combination of clauses 23-36, wherein the solvent comprises water, an alcohol, or a mixture thereof.

Clause 38. The formulation of any of one of or combination of clauses 23-37, wherein the solvent is at a pH of about 1 to 7.

Clause 39. The formulation of any of one of or combination of clauses 23-38, wherein the formulation comprises a PDMS.

Clause 40. The formulation of any of one of or combination of clauses 23-39, wherein the PDMS is terminated with a trialkoxy silane.

Clause 41. The formulation of any of one of or combination of clauses 23-40, wherein the PDMS has a molecular weight less than about 10,000 Da.

Clause 42. The formulation of any of one of or combination of clauses 23-41, wherein the molecular weight of the PDMS is at least 2,000 Da.

Clause 43. A process for forming a fingerprint-resistant coating on a substrate, the process comprising

applying a formulation for a fingerprint-resistant coating to a surface of the substrate, and

curing the formulation for a fingerprint-resistant coating on the surface of the substrate to form the fingerprint-resistant coating.

Clause 44. The process of clause 43, wherein the formulation for a fingerprint-resistant coating comprises an alkyl silane of the formula (R^{A})₃SiR^{B},

wherein each R^{A} is independently —OC₁-C₆ alkyl, —OC₂-C₆ alkenyl, or —OC₂-C₆ alkynyl;

R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, —C(O)OR¹, —C(O)OC₁-C₂₀—PO₃H₂, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, —NH₂, —NH(C₁-C₆ alkyl), —N(H)C₁-C₆ alkyl-NH₂, —N(H)C₁-C₆ alkyl-Si(˜OC₁-C₆ alkyl)₃, —N(R¹)C₁-C₆ alkyl-N(R¹)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or —Si(˜OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and

R¹ is independently deuterium, C₁-C₆ alkyl, C₂-C₆ alkenyl, C₂-C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

Clause 45. The process of any of one of or combination of clauses 43-44, wherein the fingerprint-resistant coating has an initial oil angle of at least less than about 50°.

Clause 46. The process of any of one of or combination of clauses 43-45, wherein the fingerprint-resistant coating has an initial oil angle of at least less than about 45°.

Clause 47. The process of any of one of or combination of clauses 43-46, wherein the fingerprint-resistant coating has an initial water angle of greater than about 65°.

Clause 48. The process of any of one of or combination of clauses 43-47, wherein the fingerprint-resistant coating has an initial water angle of about 70° to about 90°.

Clause 49. The process of any of one of or combination of clauses 43-48, comprising activating the surface of the substrate by exposing the surface to a plasma of at least one gas selected from the group consisting of inert gases, N₂, O₂, and a mixture of at least two of the foregoing gases.

Clause 50. The process of any of one of or combination of clauses 43-49, wherein the step of applying is performed by dipping, wiping, or spraying the formulation for a fingerprint-resistant coating onto the surface of the substrate.

Clause 51. The process of any of one of or combination of clauses 43-50, wherein the fingerprint-resistant coating has a coefficient of friction less than about 0.2.

Clause 52. The process of any of one of or combination of clauses 43-52, wherein the fingerprint-resistant coating has a coefficient of friction less than about 0.13.

Clause 53. The substrate, formulation, or process of any of the preceding clauses or any combination of the preceding clauses, wherein R^{B} is not a halo-substituted n-octyltriethoxysilane or a halo-substituted C₁-C₆ alkyl.

Clause 54. The substrate, formulation, or process of any of the preceding clauses or any combination of the preceding clauses, wherein R^{B} is C₁-C₂₀ alkyl, C₆-C₂₀ alkyl, or C₁₀-C₂₀ alkyl wherein each hydrogen atom C₁-C₂₀ alky, C₆-C₂₀ alkyl, or C₁₀-C₂₀ alkyl is optionally substituted. In some embodiments, each hydrogen atom may be independently optionally substituted by halogen, —OH, —CN, —OR¹, —CO₂H, —NH₂, —NH(C₁-C₆ alkyl), —N(C₁-C₆ alkyl)₂, —P(C₁-C₆ alkyl)₂, —P(O)(C₁-C₆ alkyl)₂, —PO₃H₂, wherein R¹ is independently deuterium or —C₁-C₆alkyl-O—C₁-C₆ alkyl.

Clause 55. The substrate, formulation, or process of any of the preceding clauses or any combination of the preceding clauses, wherein the alkyl silane comprises a halogen but does not comprise a fluoro, the alkyl silane does not comprise a PEG group, or both.

Clause 56. The substrate, formulation, or process of any of the preceding clauses or any combination of the preceding clauses, wherein the POSS is of the formula

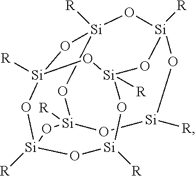

wherein R is C₁-C₆ alkyl or —O—Si—(C₁-C₆ alkyl)₃ and at least one C₁-C₆ alkyl is substituted with at least one hydroxy.

Clause 57. The substrate, formulation, or process of any of the preceding clauses or any combination of the preceding clauses, wherein a POSS is not present in the formulation for a fingerprint-resistant coating.

Clause 58. A formulation for a fingerprint-resistant coating, the formulation comprising an alkyl silane and a PDMS.

Clause 59. The formulation of any of clause 58, wherein the PDMS is terminated with a trialkoxy silane.

Clause 60. The formulation of any of one of or combination of clauses 58-59, wherein the PDMS has a molecular weight less than about 10,000 Da.

Clause 61. The formulation of any of one of or combination of clauses 58-60, wherein the molecular weight of the PDMS is at least 2,000 Da.

Clause 62. The formulation of any of one of or combination of clauses 58-61, wherein the alkyl silane is of the formula (R^{A})₃SiR^{B},

wherein each R^{A} is independently —OC₁-C₆ alkyl, —OC₂-C₆ alkenyl, or —OC₂-C₆ alkynyl;

R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, —C(O)OR¹, —C(O)OC₁-C₂₀—PO₃H₂, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, —NH₂, —NH(C₁-C₆ alkyl), —N(H)C₁-C₆ alkyl-NH₂, —N(H)C₁-C₆ alkyl-Si(˜OC₁-C₆ alkyl)₃, —N(R¹)C₁-C₆ alkyl-N(R)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or -Si(˜OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and

R¹ is independently deuterium, C₁-C₆ alkyl, C₂-C₆ alkenyl, C₂-C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

Clause 63. The formulation any of one of or combination of clauses 58-63, wherein R^{B} is C₆-C₂₀ alkyl or C₁₀-C₂₀ alkyl and each hydrogen atom in C₆-C₂₀ alkyl or C₁₀-C₂₀ is independently optionally substituted by halogen, —OH, —CN, —OR¹, —CO₂H, —NH₂, —NH(C₁-C₆ alkyl), —N(C₁-C₆ alkyl)₂, —P(C₁-C₆ alkyl)₂, —P(O)(C₁-C₆ alkyl)₂, —PO₃H₂, wherein R¹ is independently deuterium or —C₁-C₆ alkyl-O—C₁-C₆alkyl.

### EXAMPLES

The following examples are set forth for purposes of illustration only. Parts and percentages appearing in such examples are by weight unless otherwise stipulated. OH-POSS was purchased from Sigma Aldrich.

### Example 1

Activating Plasma Conditions:

According to exemplary embodiments, the substrate was treated by an activated gas in the form of a plasma. This step may be carried out in various vacuum or atmospheric-pressure chambers. For example, it is possible to use a parallel-plate RF reactor. The treatment results in a chemical modification of the substrate, but no physical alteration such as morphology. The gas used is preferably selected from Ar, He, N₂, or O₂ or a mixture of two or more of these gases. Usually, the working pressure was regulated between 50 and 500 mTorr, the power between 10 and 200 W, and the activation time was between about 1 minute and about 5 minutes, typically within 1 minute.

### Example 2

Testing and Analysis

For testing, the control was not surface treated, and the specimen was an invisible fingerprint coating on a glass specimen, which was plasma-activated. The specimens prepared as described above were evaluated according to the following test methods.

The initial contact angle measurement was carried out with water and diiodomethane, which provide a reference indication of the omniphobicity of the grafted substrate.

The transmittance test was measured percentage of the irradiance of light according to ASTM D1003.

The abrasion resistance, obtained by measuring the residual contact angle of water on the specimen after the grafted coating was abraded according to ASTM D4060 on the specimens with an abrasive disk of CS 10 hardness under a load of 250 g on an area measuring 1.5 cm², with a translational rate of 50 cycles/minute and a rotation speed of 6 rpm. A specimen is satisfactory in the test if the contact angle remains greater than 80° after 1500 cycles.

The chemical resistance test was done in a strong acid (pH 2) and base (sodium hydroxide, pH 11) environment at room temperature. A specimen is deemed satisfactory in the test if the water contact angle remains greater than 90 degrees after 8 hours.

### Example 3

Contact Angle Measurement

The invisible fingerprint coating was estimated by contact angle measurement with different fluids such as water and diiodomethane. The results obtained for the specimens prepared in accordance with the procedure above are shown in Table 1 below.

TABLE 1

| | 1 | 2 | 3 | 4 | 5 | Mean |
|---|---|---|---|---|---|---|
| Water | 81 | 80 | 78 | 82 | 77 | 80 |
| Diiodomethane | 40 | 39 | 41 | 40 | 38 | 40 |

Table 2 below shows contact angle measurements on alkylsilane (AS) without OH-POSS coating.

TABLE 2

| | 1 | 2 | 3 | 4 | 5 | Mean |
|---|---|---|---|---|---|---|
| Water | 115 | 108 | 113 | 110 | 104 | 110 |
| Diiodomethane | 40 | 39 | 41 | 40 | 38 | 40 |

### Example 4

Fingerprint Resistance and Invisibility

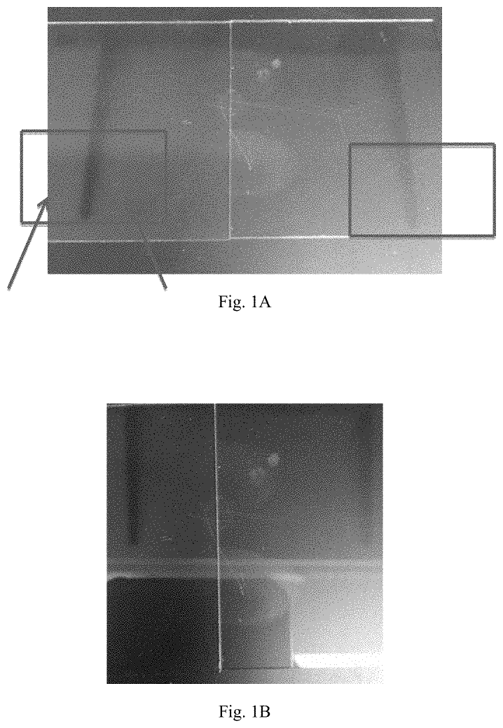

Fingerprint properties were measured by placing a fingerprint in between two substrates, coated (on left) and uncoated (on right) on each photo in FIGS. 1A and 1B of a fingerprint placed between two pieces of Gorilla® Tempered Glass. The coated substrate on the left demonstrates no fingerprint while the uncoated on the right has a clear fingerprint smudge.

### Example 5

Chemical Resistance

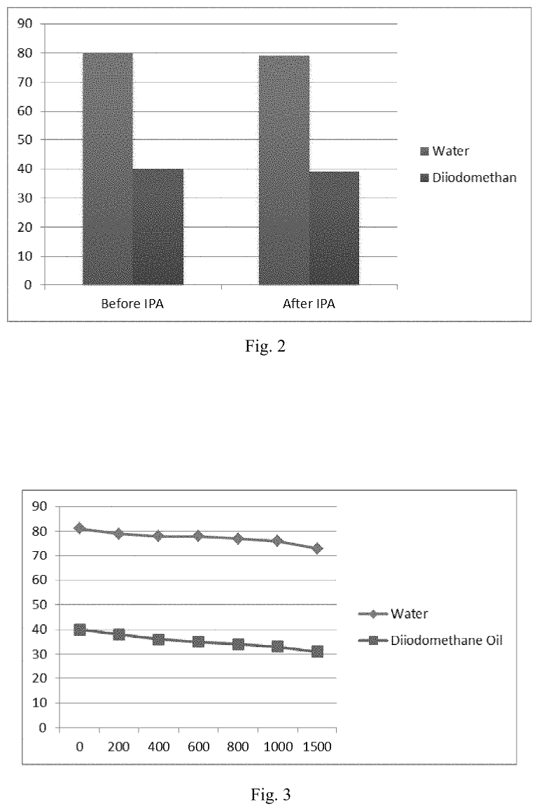

In general, hydrophobic coatings are vulnerable to hydrolysis and coating failure after exposure to harsh solvent conditions. The purpose of this test was to measure the chemical resistance properties of the substrates provided with an invisible fingerprint coating formed according to an exemplary method of the present disclosure. The test consisted of rubbing the sample with a cloth soaked in isopropanol alcohol (IPA) ten times. The test results, as seen in the chart of FIG. 2, a chemical resistance test before and after the IPA rub, showed that water contact angle and diiodomethane contact angle of the coatings were not affected by the solvent exposure.

### Example 6

Abrasion Resistance

The abrasion resistance of the omniphobic substrates obtained was measured according to ASTM D4060. The test was carried out on the specimens with an abrasive disk of CS-10 hardness under a load of 250 g on an area measuring 1.5 cm², with a translational rate of 50 cycles/minute and a rotation speed of 6 rpm. A specimen was deemed satisfactory in the test if the water contact angle remained greater than 70 degrees after 1500 cycles. The test was performed for 1,500 cycles, 3,000 cycles, or 4,500 cycles. It may be seen that the abrasion resistance properties of the specimen were sufficient and there was no marginal degradation of water contact angle, as shown in FIG. 3, which is a chart showing the results of a mechanical abrasion (ASTM D4060 Taber) test: 500 g weight load for 1,500 cycles (CS-10 wheel).

A 500 g weight was loaded to the abrasive disk of CS-10 hardness. The abrasion resistance of the specimen showed marginal degradation. Over 1,500 cycles, water contact angle stayed above the cutoff limit for water and diiodomethane (70 degrees and 30 degrees).

### Example 7

Triethoxy Undecylinic Acid Silane Synthesis

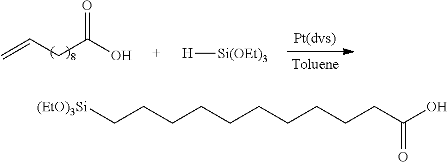

Undecylenic acid (1.0 g, 5.4 mmol, 1 eq.) and triethoxysilane (1.07 g, 6.5 mmol, 1.2 eq.) in 3 ml of anhydrous toluene were charged into 25 ml of a round bottom flask equipped with a stir bar. The reaction mixture was purged under Argon for 30 min. 0.01 ml of Pt(dvs) (about 2% Pt in xylene, available from Aldrich) was dropwise added to the reaction mixture. The reaction mixture was slowly heated up to 80° C. and left stirring at 80° C. overnight. Toluene and excess triethoxysilane were evaporated by a rotary evaporator. The resulting organic oil was filtered through celite yielding oil. Yield: 1.1 g. % Yield: 58%

### Example 8

Triethoxy Undecylhydroxy Silane Synthesis

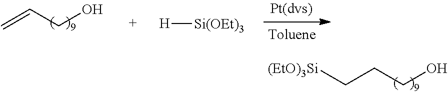

10-Undecen-1-ol (10 g, 0.059 mol, 1 eq.) and Triethoxysilane (11.6 g, 0.07 mol, 1.2 eq.) in 30 ml of anhydrous toluene were charged into 100 ml of a round bottom flask equipped with a stir bar. The reaction mixture was purged under Argon for 30 min. 0.1 ml of Pt(dvs) (about 2% Pt in xylene, available from Aldrich) was dropwise added to the reaction mixture. The reaction mixture was slowly heated up to 80° C. and left stirring at 80° C. overnight. Toluene and excess triethoxysilane were evaporated by a rotary evaporator. The resulting organic oil was filtered through celite yielding brown-oil. Yield: 6.8 g. % Yield: 34%

### Example 9

Triethoxy Hexylhydroxy Silane Synthesis

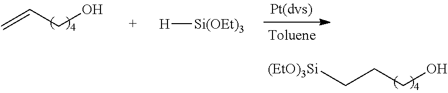

5-Hexen-1-ol (5 g, 0.05 mol, 1 eq.) and Triethoxysilane (9.84 g, 0.06 mol, 1.2 eq.) in 15 ml of anhydrous toluene were charged into 100 ml of a round bottom flask equipped with a stir bar. The reaction mixture was purged under Argon for 30 min. 0.05 ml of Pt(dvs) (about 2% Pt in xylene, available from Aldrich) was dropwise added to the reaction mixture. The reaction mixture was slowly heated up to 80° C. and left stirring at 80° C. overnight. Toluene and excess triethoxysilane were evaporated by a rotary evaporator. The resulting organic oil was filtered through celite yielding colorless oil, which turned to glossy-solid over the time. Yield: 6.15 g. % Yield: 44%

### Example 10

Phosphonoundecyl Triethoxy Silane Synthesis

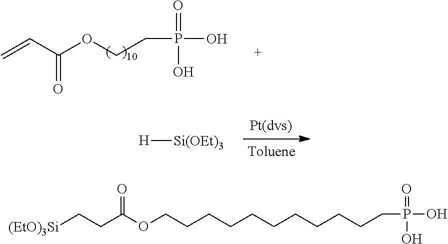

11—Phosphonoundecyl acrylate (0.75 g, 2.45 mmol, 1 eq.) and Triethoxysilane (0.48 g, 2.9 mmol, 1.2 eq.) in 2 ml of anhydrous toluene were charged into 25 ml of a round bottom flask equipped with a stir bar. The reaction mixture was purged under Argon for 30 min. 5 μl of Pt(dvs) (about 2% Pt in xylene, available from Aldrich) was dropwise added to the reaction mixture. The reaction mixture was slowly heated up to 80° C. and left stirring at 80° C. overnight. Toluene and excess triethoxysilane were evaporated by a rotary evaporator. The resulting organic oil was filtered through celite yielding colorless oil. Yield: 0.6 g. % Yield: 52%.

### Example 11

Formulations

A formulation for a fingerprint-resistant coating was prepared by mixing an alkyl silane and a POSS in a solvent. The alkyl silanes are describes below in Table 3. The OH-POSS was prepared as described in Example 1 of US Patent Application Publication No. 2017/0349785, the entirety of which is hereby incorporated by reference or purchased from Sigma Aldrich (cat. number 594180). The solvent was a mixture of 20% ethanol, 70% water, and 10% aqueous 5M NH₄OH. The formulation was prepared by combining 3.75 g/L silane with 100 mg/L of POSS in the solvent. The chloroundecyl triethoxy silane (CAS#120876315) was purchased from Gelest; the chloroundecyl trimethoxy silane (CAS#17948-05-9) was purchased from Gelest; the chlorohexyl trimethoxy silane (CAS#1145666-63-2) was purchased from Gelest; the N-(2-aminoethyl)-11-aminoundecyltrimethoxysilane (CAS#121772-92-7) was purchased from Gelest; the 11-aminoundecyl triethoxy silane (CAS#116821-45-5) was purchased from Gelest; the PEG silane (CAS #1384163-86-3) was purchased from Gelest, the hydroxydecyl triethoxy silane was made according to Example 12; the N-(6-aminohexyl) aminomethyl triethoxy silane (CAS #15129-36-9) was purchased from Gelest.

The formulations were sprayed onto a corona/plasma treated surface to fully wet the surface. Excess formulation was wiped off. The treated surface was cured in an oven at 120° C. for about 10 minutes. The initial oil angle was determined as described above in Example 2. The abrasion resistance was measured according to Example 6. The abrasion resistance results are shown in Table 4.

TABLE 3
Initial Oil Angles

| Silane | Initial Oil Angle (°) |
|---|---|
| chloroundecyl triethoxy silane | 28 |
| Chlorohexyl triethoxy silane | 30 |
| 11-aminoundecyl triethoxy silane | 43 |
| N-(2-aminoethyl)-11-aminoundecyl triethoxy | 41 |
| silane | |
| N-(6-aminohexyl) aminomethyl triethoxy silane | 45 |
| bis triethoxy octyl triethoxy silane | 47 |
| bis (trimethoxysilyl) 4-oxa-8-azundecan-6-ol | 49 |
| OH-decyl triethoxy silane | 36 |
| Phosphate undecyl triethoxy silane | 50 |
| Undecyl triethoxy silane | 50 |

TABLE 4
Abrasion Resistance

| | | Water | Water | Water |
|---|---|---|---|---|
| | | angle | angle | angle |
| | Initial | after | after | after |
| | water | 1,500 | 3,000 | 4,500 |
| | angle | cycles | cycles | cycles |
| Silane | (°) | (°) | (°) | (°) |
| chloroundecyl silane | 83 | 75 | 60 | 50 |
| Chlorohexyl silane | 60 | | | |
| amino-undecyl silane | 80 | 65 | 55 | 42 |
| N-2-aminoethyl-11-aminoundecyl | 82 | 65 | 53 | 45 |
| triethoxy silane | | | | |
| N-6-aminohexyl aminomethyl | 60 | | | |
| triethoxy silane | | | | |
| bis triethoxy octyl silane | 75 | 60 | 45 | 40 |
| bis (trimethoxysilyl) 4-oxa-8- | 71 | 32 | 31 | 30 |
| azundecan-6-ol | | | | |
| OH-decyl triethoxy silane | 88 | 65 | 50 | 40 |
| Phosphate undecyl triethoxy | 100 | | | |
| silane | | | | |
| Undecyl triethoxy silane | 110 | | | |

### Example 12

Abrasion Resistance

A formulation for a coating was prepared by mixing a silane and a POSS in a solvent as described above in Example 15. The silane was chloroundecyl triethoxy silane (CAS#120876315), purchased from Gelest. The Mono-OH POSS, was made according to Example 1 of US Patent Application Publication No. 2017/0349785, the entirety of which is hereby incorporated by reference. The Mono-PEG POSS (CAS #1838163-04-4) was purchased from Hybrid Plastics. The Sigma OH-POSS (CAS #288290-32-4), purchased from Sigma Aldrich.

TABLE 5
Abrasion Resistance

| | | | Water | Water | Water |
|---|---|---|---|---|---|
| | | | angle | angle | angle |
| | Initial | Initial | after | after | after |
| | oil | water | 1,500 | 3,000 | 4,500 |
| | angle | angle | cycles | cycles | cycles |
| | (°) | (°) | (°) | (°) | (°) |
| Mono OH-POSS | 30 | 87 | 75 | 60 | 50 |
| Mono PEG POSS | 27 | 86 | 74 | 63 | 47 |
| Sigma OH-POSS | 28 | 85 | 77 | 61 | 52 |

### Example 13

Delta E

For measuring fingerprint performance, the L A B values of the virgin glass on a black background were measured using a Konica Minolta colorimeter, ideally using black card-stock or a black OLED display. Then the operator must wipe their dominant hand with all four fingers 2-3 times on their nose or forehead, which are the oiliest part of the body. Then they will immediately tap on the glass with all four fingers with moderate force 10 times, which will result in 40 fingerprints on the surface. Then they will use a colorimeter to measure the L A B values and will use those values to calculate the delta E based on the virgin and fingerprinted glass. The lower the delta E the more invisible the fingerprints are. Then the operator will take a piece of jean material, ideally a standardized LEVIS 401 jean material and wipe the glass twice along the same area to attempt to wipe off the fingerprints. Then the operator will calculate the delta E compared to the virgin glass to measure the cleanability of the coating. The closer the value is to 0 the more invisible the fingerprint is.

This test was performed on surfaces prepared as described in Example 12. The results are shown in Table 7.

TABLE 7
Delta E values

| | Initial | Initial | | |
|---|---|---|---|---|
| | water | Oil | | Delta E |
| | angle | angle | Delta E | Post |
| | (°) | (°) | Initial | Wipe |
| Anti-Fingerprint (BASF, | 115 | 95 | 2.5 | 0.5 |
| Daikin, Shin Etsu) | | | | |
| Chloroundecyl alkyl silane + | 80 | 30 | 0.5 | 0.1 |
| OH POSS | | | | |
| OH-undecyl silane + | 80 | 35 | 0.5 | 0.2 |
| OH POSS | | | | |
| Chloroundecyl alkyl silane + | 80 | 30 | 0.5 | 0.1 |
| PEG POSS | | | | |

### Example 14

Synthesis of PDMS-TEOS

Monovinyl terminated PDMS (5k) (10 g, 0.002 mol, 1 eq.; available from Gelest) and triethoxysilane (0.5 g, 0.003 mol, 1.5 eq.) was dissolved in 5 ml anhydrous toluene and purged under Ar for 30 min. 0.1 mL of Pt(dvs) (about 2% Pt in xylene, available from Aldrich) added to reaction mixture and allowed to come 90° C. The reaction mixture was stirred at 90° C. for about 60 hours. The reaction mixture was directly filtered through celite after it cools down to room temperature. Yield: 7.9 g.

### Example 15

Synthesis of PDMS-TEOS

3-isocyanotopropyltriethoxysilane (0.197 g, 0.8 mmol, 2 eq.; available from Gelest) was combined with PDMS bisamino (1 g, 0.4 mmol, 1 eq., available from Sigma Aldrich, CAS number 106214-84-0). The mixture was stirred for up to four hours. Yield 1.1 g.

### Example 16

Formulations

OH-POSS (final concentration 100 mg/mL) was combined with chloroundecyl silane (final concentration 3.75 mg/mL) and PDMS-TEOS from Example 18 (final concentration 0.375 mg/mL) in ethanol. The solution was applied to a surface as described above.

The coefficient of friction of the coated surfaced was measured using an MDX-02 Coefficient of Friction Tester. The coefficient of friction of the surface coated with the formulation including the PDMS-TEOS was measured to be about 0.116. The coefficient of friction for the surface coated with a formulation that did not contain the PDMS-TEOS was about 0.168.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where the event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment, and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It should further be noted that any patents, applications and publications referred to herein are incorporated by reference in their entirety.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

What is claimed is:

1. A fingerprint-resistant substrate made by a process comprising,
applying a formulation for a fingerprint-resistant coating onto a surface of a substrate,
wherein the fingerprint-resistant surface has a delta E of less than 2.

2. The fingerprint-resistant substrate of claim 1, wherein the fingerprint-resistant surface has an initial oil angle of less than about 40° and an initial water angle of greater than about 65°.

3. The fingerprint-resistant substrate of claim 2, wherein the formulation for a fingerprint-resistant coating comprises an alkyl silane of the formula
(R^{A})₃SiR^{B},
wherein each R^{A} is independently —OC₁-C₆ alkyl, —OC₂-C₆ alkenyl, or —OC₂-C₆ alkynyl;
R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, C(O)OR¹, —C(O)OC₁-C₂₀—PO₃H₂, —C(O)NH₂, C(O)NH(C₁-C₆ alkyl), —C(O)N(C₁-C₆ alkyl)₂, SC₁-C₆ alkyl, S(O)C₁-C₆ alkyl, —S(O)₂C₁-C₆ alkyl, —S(O)NH(C₁-C₆ alkyl), —S(O)₂NH(C₁-C₆ alkyl), S(O)N(C₁C₆ alkyl)₂, —S(O)₂N(C₁-C₆ alkyl)₂, —NH₂, NH(C₁-C₆ alkyl), —N(H)C₁-C₆ alkyl-NH₂, N(H)C₁-C₆ alkyl-Si(˜OC₁-C₆ alkyl)₃, —N(R¹)C₁-C₆ alkyl-N(R¹)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or Si(OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and
R¹ is independently deuterium, C₁-C₆ alkyl, C₂-C₆ alkenyl, C₂C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

4. The fingerprint-resistant substrate of claim 3, wherein R^{B} is C₆-C₂₀ alkyl and each hydrogen atom in C₆-C₂₀ alkyl is independently optionally substituted by halogen, —OH, —CN, —OR¹, —CO₂H, —NH₂, NH(C₁-C₆ alkyl), —N(C₁-C₆ alkyl)₂, —P(C₁-C₆ alkyl)₂, —P(O)(C₁-C₆ alkyl)₂, or —PO₃H₂, wherein R¹ is independently deuterium or —C₁-C₆ alkyl-O—C₁-C₆alkyl.

5. The fingerprint-resistant substrate of claim 4, wherein the alkyl silane is selected from the group consisting of (chloroundecyl)(triethoxy)silane, (chloroundecyl)(trimethoxy)silane, (chlorohexyl)(triethoxy)silane, (chlorohexyl)(trimethoxy)silane, 11-(2-methoxyethoxy)undecyltrimethoxysilane, (aminoundecyl)(triethoxy)silane, (aminoundecyl)(trimethoxy)silane, (hydoxydecyl)(triethoxy)silane, (hydoxydecyl)(trimethoxy)silane, (11-undecylinicacid)(triethoxy)silane, (hydroxyheptyl)(triethoxy) silane, (hydroxyundecyl)(triethoxy)silane, and (11-phosphoundecyl)(triethoxy)silane.

6. The fingerprint-resistant substrate of claim 1, wherein the formulation for a fingerprint-resistant coating comprises a POSS of the formula 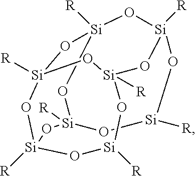
wherein R is —C₁-C₆ alkyl, -A^{E}-O—B^{F}-C^{G}-O-D^{H}, or —O-Si(C₁-C₆ alkyl)₃, wherein A is C₁-C₆ alkyl, B is —C₁-C₆ alkyl-O—, C is C₁-C₆ alkyl, D is C₁-C₆ alkyl, O is oxygen, each of E, G, and H is at least 1, and F is an integer from 5 to 12, and wherein each hydrogen atom in C₁C₆ alkyl is independently optionally substituted with deuterium, halogen, —OH, —CN, —OR², OC₁-C₆ alkyl, —NH₂, NH(C₁-C₆ alkyl), —NH(C₁-C₆ alkyl), —N(H)C₁-C₆ alkyl-NH₂, —N(C₁-C₆ alkyl)₂, —P(C₁-C₆ alkyl)₂, —P(O)(C₁-C₆ alkyl)₂, or —OPO₃H; and
wherein R² is independently deuterium, C₂-C₆ alkenyl, C₂-C₆ alkynyl, C₃-C₆ cycloalkyl, or —CC₁-C₆ alkyl-O—C₁-C₆ alkyl.

7. The fingerprint-resistant substrate of claim 6, wherein R is -A^{E}-O—B^{F}-C_{G}-O-D^{H} or —O—Si(C₁-C₆ alkyl)₃.

8. The fingerprint-resistant substrate of claim 1, wherein the fingerprint-resistant substrate has a coefficient of friction less than about 0.2.

9. The fingerprint-resistant substrate of claim 1, wherein the substrate is comprises at least one material selected from the group consisting of glass, metal oxide, and acrylic polymer.

10. The fingerprint-resistant substrate of claim 1, wherein the fingerprint-resistant substrate has an initial oil angle of at least less than about 40°.

11. The fingerprint-resistant substrate of claim 10, wherein the fingerprint-resistant substrate has an initial water angle of about 70° to about 90°.

12. A formulation for a fingerprint-resistant coating, the formulation comprising
an alkyl silane,
a POSS, and
a solvent,
wherein the alkyl silane is of the formula
(R^{A})₃SiR^{B},
wherein each R^{A} is independently —OC₁-C₆ alkyl, —OC₂-C₆ alkenyl, or —OC₂-C₆ alkynyl;
R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, C(O)OR¹, —C(O)OC₁-C₂₀—PO₃H₂, —C(O)NH₂, C(O)NH(C₁-C₆ alkyl), —C(O)N(C₁-C₆ alkyl)₂, SC₁-C₆ alkyl, S(O)C₁-C₆ alkyl, —S(O)₂C₁-C₆ alkyl, —S(O)NH(C₁-C₆ alkyl), —S(O)₂NH(C₁-C₆ alkyl), S(O)N(C₁C₆ alkyl)₂, —S(O)₂N(C₁-C₆ alkyl)₂, —NH₂, NH(C₁-C₆ alkyl), —N(H)C₁-C₆ alkyl-NH₂, N(H)C₁-C₆ alkyl-Si(˜OC₁-C₆ alkyl)₃, —N(R¹)C₁-C₆ alkyl-N(R)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or Si(OC₁-C₆ alkyl)₃; and wherein each hydrogen atom in C₁-C₆ alkyl of —N(H)C₁-C₆ alkyl-O—C₁-C₆ alkyl-Si(˜OC₁-C₆ alkyl)₃ is optionally substituted with hydroxy; and
R¹ is independently deuterium, C₁-C₆ alkyl, C₂-C₆ alkenyl, C₂C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

13. The formulation of claim 12, wherein R^{B} is C₆-C₂₀ alkyl and each hydrogen atom in C₆-C₂₀ alkyl is independently optionally substituted by halogen, —OH, —CN, —OR¹, —CO₂H, —NH₂, NH(C₁-C₆ alkyl), —N(C₁-C₆ alkyl)₂, —P(C₁-C₆ alkyl)₂, —P(O)(C₁-C₆ alkyl)₂, —PO₃H₂, wherein R¹ is independently deuterium or —C₁-C₆alkyl-O—C₁-C₆alkyl.

14. The formulation of claim 13, wherein the alkyl silane is selected from the group consisting of (chloroundecyl)(triethoxy)silane, (chloroundecyl)(trimethoxy)silane, (chlorohexyl)(triethoxy)silane, (chlorohexyl)(trimethoxy) silane, 11-(2-methoxyethoxy)undecyltrimethoxysilane, (aminoundecyl)(triethoxy)silane, (aminoundecyl)(trimethoxy)silane, (hydoxydecyl)(triethoxy)silane, (hydoxydecyl)(trimethoxy)silane, (11undecylinicacid)(triethoxy)silane, (hydroxyheptyl)(triethoxy) silane, (hydroxyundecyl)(triethoxy)silane, and (11-phosphoundecyl)(triethoxy)silane.

15. The formulation of claim 12, wherein the POSS is of the formula 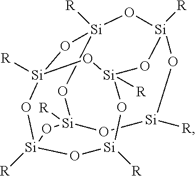
wherein R is —C₁-C₆ alkyl, -A^{E}-O—B^{F}-C^{G}-O-D^{H}, or —O-Si(C₁-C₆ alkyl)₃, wherein A is C₁-C₆ alkyl, B is —C₁-C₆ alkyl-O—, C is C₁-C₆ alkyl, D is C₁-C₆ alkyl, O is oxygen, each of E, G, and H is at least 1, and F is an integer from 5 to 12, and wherein each hydrogen atom in C₁C₆ alkyl is independently optionally substituted with deuterium, halogen, —OH, —CN, —OR², OC₁-C₆ alkyl, —NH₂, NH(C₁-C₆ alkyl), —NH(C₁-C₆ alkyl), —N(H)C₁-C₆ alkyl-NH₂, —N(C₁-C₆ alkyl)₂, P(C₁-C₆alkyl)₂, —P(O)(C₁-C₆ alkyl)₂, or —OPO₃H; and
wherein R² is independently deuterium, C₂-C₆ alkenyl, C₂-C₆ alkynyl, C₃-C₆ cycloalkyl, or —CC₁-C₆ alkyl-O—C₁-C₆ alkyl.

16. The formulation of claim 12, wherein the formulation comprises a PDMS.

17. The formulation of claim 16, wherein the PDMS is amino terminated.

18. A process for forming a fingerprint-resistant coating on a substrate, the process comprising
applying a formulation for a fingerprint-resistant coating to a surface of the substrate, and
curing the formulation for a fingerprint-resistant coating on the surface of the substrate to form the fingerprint-resistant coating,
wherein the initial oil angle of the fingerprint-resistant coating is less than about 40° and the coefficient of friction of the fingerprint-resistant coating is less than about 0.15.

19. The process of claim 18, wherein the formulation for a fingerprint-resistant coating comprises an alkyl silane of the formula
(R^{A})₃SiR^{B},
wherein each R^{A} is independently —OC₁-C₆ alkyl, —OC₂-C₆ alkenyl, or —OC₂-C₆ alkynyl;
R^{B} is C₁-C₂₀ alkyl, C₂-C₂₀ alkenyl, or C₂-C₂₀ alkynyl; wherein each hydrogen atom in —OC₁-C₆ alkyl, —OC₂-C₆ alkenyl, —OC₂-C₆ alkynyl, C₁-C₂₀ alkyl, C₂-C₂₀ alkenyl, or C₂-C₂₀ alkynyl is independently optionally substituted with deuterium, halogen, —OH, —CN, —OR¹, —CO₂H, C(O)OR¹, —C(O)OC₁-C₂₀—PO₃H₂, —C(O)NH₂, C(O)NH(C₁-C₆ alkyl), —C(O)N(C₁-C₆ alkyl)₂, SC₁-C₆ alkyl, S(O)C₁-C₆ alkyl, —S(O)₂C₁-C₆ alkyl, —S(O)NH(C₁-C₆ alkyl), —S(O)₂NH(C₁-C₆ alkyl), S(O)N(C₁C₆ alkyl)₂, —S(O)₂N(C₁-C₆ alkyl)₂, —NH₂, NH(C₁-C₆ alkyl), —N(H)C₁-C₆ alkyl-NH₂, N(H)C₁-C₆ alkyl-Si(˜OC₁-C₆ alkyl)₃, —N(R¹)C₁-C₆ alkyl-N(R)C₁-C₆ alkyl-Si(˜OC₁-C₆ alkyl)₃, —N(H)C₁-C₆ alkyl-OC₁-C₆ alkyl-Si(˜OC₁-C₆ alkyl)₃, —N(H)C₁-C₆ alkyl-N(H)C₁-C₆ alkyl-NH₂, —P(C₁-C₆ alkyl)₂, —P(O)(C₁-C₆ alkyl)₂, —PO₃H₂, or Si(OC₁-C₆ alkyl)₃; and wherein each hydrogen atom in C₁-C₆ alkyl of —N(H)C₁-C₆ alkyl-O—C₁-C₆ alkyl-Si(—OC₁-C₆ alkyl)₃ is optionally substituted with hydroxy; and
R¹ is independently deuterium, C₁-C₆ alkyl, C₂-C₆ alkenyl, C₂C₆ alkynyl, C₃-C₆ cycloalkyl, or —C₁-C₆ alkyl-O—C₁-C₆ alkyl, wherein each hydrogen atom in C₁-C₆ alkyl is optionally substituted with hydroxy.

20. The process of claim 18, wherein the step of applying is performed by chemical vapor deposition, physical vapor deposition, dipping, wiping, or spraying the formulation for a fingerprint-resistant coating onto the surface of the substrate.
